(19) United States
(12) Patent Application Publication
(10) Pub. No.: US 2026/0065902 A1
(43) Pub. Date: Mar. 5, 2026

(54) METHOD AND APPARATUS FOR GENERATING A RECORD OF AN EVENT OR A CONVERSATION

(71) Applicant: STAT LABS INCORPORATED, Mississauga (CA)

(72) Inventor: Kevin Xiang ZHOU, Mississauga (CA)

(21) Appl. No.: 18/821,184

(22) Filed: Aug. 30, 2024

(51) Int. Cl. G10L 15/08; G10L 15/26

(52) U.S. Cl. CPC G10L 15/08; G10L 15/26

(57) ABSTRACT

A method of generating a record for an event based on audio data of the event involves retrieving an event template and determining whether the event template includes a placeholder intent field and/or a generator intent field. If the event template includes the placeholder intent field, a machine learning model may be prompted to search a transcript of the audio data for placeholder information to populate the at least one placeholder intent field. This may involve determining if the placeholder information is absent from the transcript, and if the placeholder information is absent from the transcript, prompting the machine learning model to generate a re-prompt to a user to provide the placeholder information. If the event template includes the generator intent field, the machine learning model may be prompted to process the transcript to generate generator information to populate the at least one generator intent field.

### FIELD

The present disclosure relates generally to prompting a machine learning model to generate a record of an event or a conversation. More particularly, the present disclosure relates to prompting the machine learning model to generate the record based on audio data of the event or conversation and an event template.

### BACKGROUND

Generative language models may be large neural network predictive models which determine probabilities for a next word conditional on previous or historical words. Large language models (LLMs) are an example of a generative language model. LLMs may be responsive to input prompts including one or more of input data, instructions, and context.

### SUMMARY

Events and conversations may occur often in everyday life. It would be desirable to have a record of these events or conversations, which may be referenced in the future. Further, in a healthcare setting, conversations occur during each clinical interaction between a healthcare provider (e.g., a doctor, dentist, nurse, physician's assistant etc.) and a patient. The healthcare provider is required to generate a record of such medical interactions to be added to the patient's medical history (commonly referred to as a medical record). However, it can be time-consuming and burdensome to generate these records. For example, healthcare providers may spend a significant amount of time in generating the medical record at the end of a workday. Further, as healthcare providers may have a large number of medical interactions in any given day, they may have difficulty recalling the correct details of the conversation and taking appropriate follow-up actions when they generate the medical records at the end of the workday.

It is possible to record audio of these events and conversations and to generate a written record based on the recorded audio. However, it would be time-consuming to listen to the entire recorded audio or to read a transcript of the entire recorded audio. It would be desirable to generate a succinct and accurate record of these events and conversations based on the recorded audio. However, it can be difficult to process such recorded audio or the transcript accurately as there are nuances in audio dialogue during a conversation which may be difficult to convey in a text-based record (e.g., speaker emotion, speaker intention, etc.).

In this regard, LLMs (e.g., GPT-4, GPT-3, GPT-3.5, Claude 2) which have been trained on vast amounts of text may be better suited to processing recorded audio and the transcript to extract the speaker nuances during the conversation. However, simply asking such LLMs to “summarize” the event or conversation based on the audio data or to “generate a record” of the event or conversation based on the audio data may result in such LLMs randomly selecting unimportant parts of the event or conversation or inadvertently omitting or misrepresenting important details of the event or conversation. These issues may stem from the training data used to train the LLMs and may also be due to technical limitation of an input prompt limit of such LLMs caused by an underlying size of a position embedding matrix of such LLMs, or an output size of certain transformation layers of such LLMs.

Some events and conversations may have a specific and repeating structure. For example, conversations which occur during the medical interaction may involve the patient providing a summary of their ailments or complaints, the healthcare provider asking additional questions to the patient with respect to their ailments or complaints, the patient providing additional information in response to the questions raised by the healthcare provider, and the healthcare provider providing an assessment and a treatment plan. Conversations which occur during a business meeting may involve a first party outlining their position and a second party outlining their position, and both parties reaching a consensus. As a solution to the above issues, the specific and repeating structures of these events and conversations may be used to generate a corresponding event template. Different event templates may be associated with different event types (e.g., an event type categorized as “healthcare visit” may be associated with a healthcare visit event template and an event type categorized as “business meeting” may be associated with a business meeting event template). Such event templates may be used to orient and assist the LLM in generating the text-based record of these events and conversations based on recorded audio data of these events and conversations.

The present disclosure describes a method of prompting machine learning models to populate different types of fields of an event template with different types of information. The event template may correspond to an event type of an event that is recorded in audio data. The different respective information may include placeholder information retrieved from a transcript of the audio data, generator information generated from the transcript, and verbatim information carried over from the event template. Such a method enables different types of fields of the event template to be populated differently, which may help to increase efficiency and accuracy of using the machine learning model to generate a record of the event.

Furthermore, when specific details (e.g., placeholder information) are determined to be absent from the transcript, the machine learning model may further be prompted to generate a re-prompt requesting the missing (absent) details from the user. The re-prompt may be a question generated by the machine learning model based on the field (e.g., of the event template) associated with the missing (absent) details. Such a method may help to generate a comprehensive record.

Further still, the machine learning model may also be prompted to edit a generated record by the user. Such a method may allow the user to edit the record without excessive inputs.

In one embodiment, there is provided a method of generating a record for an event based on audio data of the event. The method comprises: retrieving an event template associated with the event; determining whether the event template includes at least one placeholder intent field and/or at least one generator intent field; and in response to determining that the event template includes the at least one placeholder intent field, prompting a machine learning model to search a transcript of the audio data for placeholder information associated with the at least one placeholder intent field to populate the at least one placeholder intent field. Prompting the machine learning model to search the transcript comprises: determining if the placeholder information associated with the at least one placeholder intent field is absent from the transcript; and in response to determining that the placeholder information associated with the at least one placeholder intent field is absent from the transcript, prompting the machine learning model to generate a re-prompt to a user to provide the placeholder information. The method further comprises, in response to determining that the event template includes the at least one generator intent field, prompting the machine learning model to process the transcript to generate generator information to populate the at least one generator intent field.

The method may further comprise: receiving an input from the user as a response to the re-prompt; and prompting the machine learning model to process the input of the user to populate the at least one placeholder intent field.

The re-prompt may comprise a question to the user generated by the machine learning model based on the at least one placeholder intent field. The method may further comprise: receiving an input from the user as an answer to the question; and prompting the machine learning model to process the input of the user to populate the at least one placeholder intent field.

Prompting the machine learning model to search the transcript for the placeholder information may comprise providing text of the at least one placeholder intent field and at least a portion of the transcript to the machine learning model. Prompting the machine learning model to process the transcript to generate the generator information may comprise providing text of the at least one generator intent field and at least a portion of the transcript to the machine learning model.

The method may further comprise: determining whether the event template includes at least one verbatim intent field; and in response to determining that the event template includes the at least one verbatim intent field, reproduce verbatim information associated with the at least one verbatim intent field from the event template to populate the at least one verbatim intent field.

The method may further comprise dividing the event template into a plurality of segments. Determining whether the event template includes the at least one placeholder intent field and/or the at least one generator intent field may include: identifying if a segment of the plurality of segments is associated with one or more placeholder intent identifiers; and identifying if a segment of the plurality of segments is associated with one or more generator intent identifiers.

Identifying if the segment of the plurality of segments is associated with the one or more placeholder intent identifiers may comprise determining if the segment is delimited by one or more square brackets.

Identifying if the segment of the event template is associated with the one or more generator intent identifiers may comprise determining if the segment is delimited by one or more angled brackets.

The method may further comprise: receiving a modification input from the user, the modification input including a selected portion of the record and modification instructions for modifying the selected portion; and prompting the machine learning model to generate a replacement portion to replace the selected portion based on the modification input and the transcript.

The method may further comprise recording the audio data of the event with at least one device.

The method may further comprise: converting the audio data of the event into the transcript; prompting the machine learning model to classify the transcript with an event type identifier; and retrieving the event template based on the classified event type identifier of the transcript.

The method may further comprise, in response to determining that the classified event type identifier does not correspond to any event type identifier saved in an event template datastore, outputting one or more event type identifiers for the user to manually select.

In another embodiment, there is provided a system of generating a record for an event based on an audio data of the event. The system comprises a processor and a non-transitory computer readable storage medium storing instructions which, when executed by the processor, cause the processor to: retrieve an event template associated with the event; determine whether the event template includes at least one placeholder intent field and/or at least one generator intent field; and in response to determining that the event template includes the at least one placeholder intent field, prompt a machine learning model to search a transcript of the audio data for placeholder information associated with the at least one placeholder intent field to populate the at least one placeholder intent field. The instructions which cause the processor to prompt the machine learning model to search the transcript comprise instructions which cause the processor to: determine if the placeholder information associated with the at least one placeholder intent field is absent from the transcript; and in response to determining that the placeholder information associated with the at least one placeholder intent field is absent from the transcript, prompt the machine learning model to generate a re-prompt to a user to provide the placeholder information. The non-transitory computer readable storage medium further stores instructions which, when executed by the processor, cause the processor to, in response to determining that the event template includes the at least one generator intent field, prompt the machine learning model to process the transcript to generate generator information to populate the at least one generator intent field.

The instructions may further cause the processor to: receive an input from the user as a response to the re-prompt; and prompt the machine learning model to process the input of the user to populate the at least one placeholder intent field.

The re-prompt may comprise a question to the user generated by the machine learning model based on the at least one placeholder intent field. The instructions may further cause the processor to: receive an input from the user as an answer to the question; and prompt the machine learning model to process the input of the user to populate the at least one placeholder intent field.

The instructions may further cause the processor to: determine whether the event template includes at least one verbatim intent field; and in response to determining that the event template includes the at least one verbatim intent field, reproduce verbatim information associated with the at least one verbatim intent field from the event template to populate the at least one verbatim intent field.

The instructions may further cause the processor to divide the event template into a plurality of segments. The instructions which cause the processor to determine whether the event template includes the at least one placeholder intent field and/or the at least one generator intent field may comprise instructions which cause the processor to: identify if a segment of the plurality of segments is associated with one or more placeholder intent identifiers; and identify if a segment of the plurality of segments is associated with one or more generator intent identifiers.

The instructions may further cause the processor to: receive a modification input from the user, the modification input including a selected portion of the record and modification instructions for modifying the selected portion; and prompt the machine learning model to generate a replacement portion to replace the selected portion based on the modification input and the transcript.

The system may further comprise at least one device configured to record the audio data of the event.

In another embodiment, there is provided a non-transitory computer-readable medium storing instructions thereon. The instructions are executable by a processor to cause the processor to perform a method of generating a record for an event. The method comprises: retrieving an event template associated with the event; determining whether the event template includes at least one placeholder intent field and/or at least one generator intent field; and in response to determining that the event template includes the at least one placeholder intent field, prompting a machine learning model to search a transcript of audio data of the event for placeholder information associated with the at least one placeholder intent field to populate the at least one placeholder intent field. Prompting the machine learning model to search the transcript comprises: determining if the placeholder information associated with the at least one placeholder intent field is absent from the transcript; and in response to determining that the placeholder information associated with the at least one placeholder intent field is absent from the transcript, prompting the machine learning model to generate a re-prompt to a user to provide the placeholder information. The method further comprises, in response to determining that the event template includes the at least one generator intent field, prompting the machine learning model to process the transcript to generate generator information to populate the at least one generator intent field.

Other aspects and features of the present disclosure will become apparent to those ordinarily skilled in the art upon review of the following description of specific embodiments of the disclosure in conjunction with the accompanying figures.

### BRIEF DESCRIPTION OF DRAWINGS

Reference will now be made, by way of example, to the accompanying drawings which show example embodiments of the present application, and in which:

FIG. 1 is a schematic diagram of a conversation at an event between a first party and a second party, and a software platform used to audio data generated during the conversation in accordance with some embodiments;

FIG. 2 is a schematic of a remote server and a device of the software platform of FIG. 1 in accordance with some embodiments;

FIG. 3 is a block diagram of a simplified transformer neural network, which may be used in some embodiments of the present disclosure;

FIG. 4 is a flowchart of a generate/modify event template process executed at the remote server or the device of FIG. 2 in accordance with some embodiments;

FIGS. 5A and 5B are schematic representations of event templates generated by the generate/modify event template process of FIG. 4 in accordance with some embodiments;

FIGS. 6A and 6B are flowcharts of a populate event template process executed at the remote server or the device of FIG. 2 in accordance with some embodiments;

FIGS. 7A and 7B are schematic representations of records generated by the populate event template process of FIGS. 6A and 6B based on the event template of FIG. 5A in accordance with some embodiments;

FIG. 7C is a schematic representation of pre-prompts generated by the populate event template process of FIGS. 6A and 6B based on the event template of FIG. 5A in accordance with some embodiments;

FIG. 8 is a flow chart a modify record process executed at the remote server or the device of FIG. 2 in accordance with some embodiments;

FIGS. 9A and 9B are schematic representations of records modified by the modify record process of FIG. 8 in accordance with some embodiments.

Similar reference numerals may have been used in different figures to denote similar components.

In the drawings, embodiments are illustrated by way of example. It is to be expressly understood that the description and drawings are only for purposes of illustrating certain embodiments and are an aid for understanding. They are not intended to be a definition of the limits of the invention.

### DETAILED DESCRIPTION

The present disclosure is made with reference to the accompanying drawings, in which certain non-limiting embodiments are shown. However, the description should not be construed as being limited to the embodiments set forth herein. Rather, these embodiments are provided as examples. Like numbers refer to like elements and like components throughout. Separate boxes or illustrated separation of functional elements or modules of illustrated systems and devices does not necessarily require physical separation of such elements or modules, as communication between such elements can occur by way of messaging, function calls, shared memory space, and so on, without any such physical separation. As such, elements or modules need not be implemented in physically or logically separated platforms, although they may be illustrated separately for ease of explanation herein. Different devices can have different designs, such that while some devices implement some functions in fixed function hardware, other devices can implement such functions in a programmable processor with code obtained from a machine readable medium.

Embodiments of the present disclosure herein relate to using a generative language model (e.g., an LLM as described below, OTS LLMs such as GPT-4, GPT-3, GPT-3.5, Claude 2) to classify a conversation or an event with a particular event type identifier based on audio data of the conversation or the event, to retrieve a relevant event template based on the classified event type identifier, to populate the event type template based on the audio data (or a transcript of the audio data), to generate a record of the conversation or the event based on the transcript and the event template, and to modify the record based on additional user input.

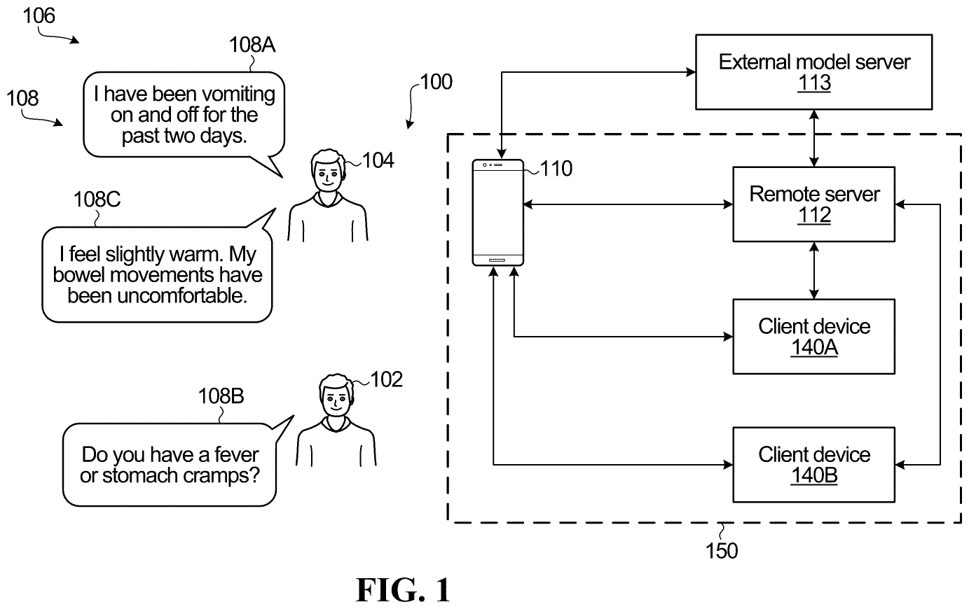

FIG. 1 is a schematic diagram illustrating an example audio data generation event 100. During this event 100, a first party 102 is having a conversation 106 with a second party 104. The event 100 may be a healthcare visit (e.g., at a doctor's office, at a dentist's office, in a surgical room), a service visit, a lecture, etc. The conversation 106 is spoken aloud and includes various utterances 108A-C (collectively, utterances 108) spoken by the first party 102 and by the second party 104.

In embodiments where the event is a healthcare visit, the first party 102 may be a healthcare provider (e.g., a doctor, dentist, nurse, physician's assistant etc.), and the second party 104 may be a patient. In other embodiments where the event is a healthcare visit, the first party 102 may be an attending surgeon, whereas the second party 104 may be residents, fellows or nurses, or vice versa. In other embodiments, the event 100 may include other types of events, the first and second parties 102 and 104 may be any other types of individuals that engage in the conversation 106 or are present at the event 100, such as a lecturer and a student during a lecture, a service provider and a customer at a service centre, a salesperson and a customer at a shop, attendees of a business meeting, etc. Further, although only two parties 102 and 104 are shown in FIG. 1, in other embodiments, more than two parties may contribute to the conversation 106 or may be present at the event 100.

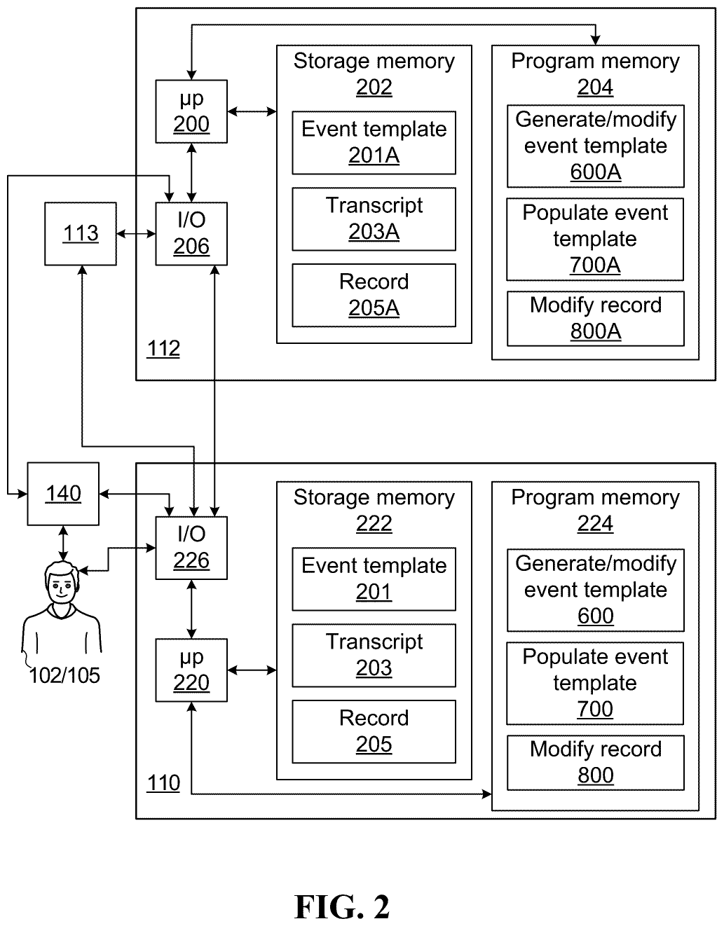

Referring now to FIGS. 1 and 2, a block diagram illustrating a software platform operable to implement the above embodiments is shown generally at 150. The software platform 150 includes a remote server 112, a device 110 operable to record the conversation 106 to generate the audio data associated with the conversation 106 (or the event 100) and to generate additional audio data associated with the first party 102 or a user 105 after the conversation 106 (or the event 100), and a plurality of client devices 140 (illustrated as 140A and 140B in FIG. 2, reference character “140” as used herein may refer to any one client device of the plurality of client devices or the plurality of client devices as a whole) operable to access and/or update a record 130 of the conversation 106 (or the event 100). In certain embodiments, the device 110 may be one of the client devices 140 and one of the client devices 140 may be the device 110. The user 105 may be the first party 102 or may be another individual who is granted access to the record 130, including the second party 104, users authorized by the first party 102 (e.g., nurses, fellows, residents, physician's assistants) or users authorized by the second party 104 (e.g., family members of the patient). In some situations, the user 105 may only be allowed to access the record 130 and not to modify or update the record 130.

The term “record” refers to a text-based material documenting the conversation 106 (or the event 100). The terms “transcript record”, “appointment record”, “transcript note”, “appointment note”, “transcript file” may be used interchangeably herein.

### Device 110

The device 110 may be any component (or collection of components) that is capable of recording the audio data associated with the conversation 106 (or the event 100) or additional audio data generated with the first party 102 or the user 105 after the conversation 106 (or the event 100). For example, the device 110 may include, without limitation cellphones, dictation devices, laptops, desktops, tablets, personal assistant devices, or the like. The audio data associated with the conversation 106 (or the event 100) may include an audio recording of the utterances 108 by the first party 102 and the second party 104 during the conversation 106 (or the event 100), environmental noises during the conversation 106 (or the event 100), etc. The additional audio data generated by the first party 102 or the user 105 may include subsequent utterances by the first party 102 or the user 105 after the conversation 106 (or the event 100) has occurred. The device 110 may also, alone or in combination with the remote server 112 and the client device 140, (a) store the audio data, event template 120 and the records 130 as described below, (b) receive user input to generate the event templates 120 as described below, (c) process the audio data, the additional audio data and the event templates 120 to generate the records 130 as described below, and (d) process the audio data, the additional audio data and the event templates 120 to update the records 130 as described below. The device 110 may transmit the audio data (or the additional audio data) or the event templates 120 to the remote server 112 or the client device 140, locally store or cache the audio data (or the additional audio data) or the event templates 120 for subsequent processing by the device 110 (locally or remotely), or combinations thereof. In various embodiments, the device 110 may also pre-process the audio data (or the additional audio data) to remove or filter out the environmental noise, compress the audio data, remove undesired sections of the conversation 106 (e.g., silences or other portions indicated by the first party 102 or the user 105 to remove), which may reduce data transmission loads or otherwise increase the speed of transmission of the audio data to the remote server 112 or the client devices 140.

In the embodiment shown in FIGS. 1 and 2, there is only a single device 110; in other embodiments, there may be more than one device 110 at a location of the conversation 106 or the event 100. In various embodiments, the device 110 includes at least one device processor 220, and a storage memory 222, a program memory 224 and an input/output (I/O) interface 226 all in communication with the device processor 220. Other embodiments of the device 110 may include fewer, additional or alternative components. Other processing system architectures may be suitable for implementing the device 110 and may include components different from those discussed below. Additionally, although only a single device processor 220, a single storage memory 222, a single program memory 224, and a single I/O interface 226 is shown in FIG. 2, other embodiments of the summary server 506 may include more than one of each of these components.

The storage memory 222 stores information received or generated by the device processor 220 and may generally function as an information or datastore. In the embodiment shown, the storage memory 222 includes an event template datastore 201 for storing the event templates 120, a transcript datastore 203 for storing transcripts of the audio data (or the additional audio data) and a record datastore 205 for storing the records 130 and records 130; in other embodiments, the storage memory 222 may include fewer, additional or alternative datastores. The program memory 224 stores various blocks of code (alternatively called processor, machine and/or computer executable instructions), including codes for directing the device processor 220 to perform various processes, such as generate/modify event template process 600, a populate event template process 700 and a modify record process 800 as described below. The program memory 224 may also store database management system codes for managing the datastores in the storage memory 222. In other embodiments, the program memory 224 may store fewer, additional or alternative codes for directing the device processor 220 to execute additional or alternative functions. The storage memory 222 and the program memory 224 may each be implemented as one or a combination of a non-transitory computer-readable and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The I/O interface 226 comprises a network interface for receiving and transmitting information between the device 110 and different systems within the software platform 150, including the remote server 112 and/or the client devices 140. The I/O interface 226 further comprises a user interface for allowing the first party 102 or the user 105 to generate the audio data (or the additional audio data) and to provide further user input. The I/O interface 226 may include any communication interface which enables the device processor 220 to communicate with external components, including specialized or standard I/O interface technologies such as channel, port-mapped, asynchronous for example. In some embodiments, the I/O interface 226 may be implemented using a network interface card (NIC), a port, and/or a network socket. The I/O interface 226 may further include specific user input devices, including without limitation microphone, keyboard, and/or touchscreen. The I/O interface 226 may also include output devices, including without limitation a display and a speaker. For example, the device 110 may receive the audio data (or the additional audio data) and user input and transmit the audio data and the user input to the remote server 112 for processing thereof to generate the record 130 using the I/O interface 226. The remote server 112 may have increased processing capacity and computing resources for processing the audio data when compared to the device 110. As a further non-nonlimiting example, the device 110 also communicate with additional systems over the I/O interface 226, including an external model server 113 hosting the LLM described below. The external model server 113 may have increased processing capacity and computing resources for training and/or fine-tuning various machine learning models, including the generative language models described below.

The device processor 220 may be configured to execute codes stored in the program memory 224, to retrieve information from and store information into the databases of the storage memory 222, and to receive and transmit information to the remote server 112 and/or the client devices 140 over the I/O interface 226, examples of which are described below.

### Client Devices 140

The client devices 140 may be, for example, a mobile phone, or a tablet, or a laptop, or a personal computer, etc. A client device 140 may include a processor for performing the operations of the client device 140 (e.g., by executing instructions stored in a program memory of the client device 140 and to store data and information in a storage memory of the client device 140), a network interface (e.g., a transmitter/receiver with an antenna or a network interface card or a port) for communicating with server 112 and/or the device 110 and a user interface (e.g., microphone, keyboard, display, and/or touchscreen) allowing the first party 102 or the user 105 to provide.

The client device 140 may generally allow the first party 102 or the user 105 to access and potentially modify the record 130 after the conversation 106 (or the event 100) has occurred. The user interface of the client device 140 may thus generally be configured to receive the subsequent utterances by the first party 102 or the user 105 after the conversation 106 has occurred and to generate the additional audio data therefrom. As noted above, in some embodiments, the device 110 may be one of the client devices 140, and one of the client devices 140 may be the device 110. In the embodiment shown in FIGS. 1 and 2, there is only a two client devices 140A and 140B; in other embodiments, there may be more than two client devices 140 which are allowed to access and modify the record 130.

The storage memory of the client device 140 may include copies or corresponding versions of one or more of the event template datastore 201, the transcript datastore 203 and the record datastore 205. In some embodiments, the device 110 and the client device 140 may work in combination to store the event templates 120 in the corresponding event template datastore 201, the transcripts of the audio (or the additional audio) in the corresponding transcript datastore 203 and the records 130 and the records 130 in the corresponding record datastore 205 as described below.

The program memory of the client device 140 may include copies or corresponding versions of the generate/modify event template process 600, the populate event template process 700 and the modify record process 800. In some embodiments, the device 110 and the client device 140 may work together in combination to perform the generate/modify event template process 600, the populate event template process 700 and the modify record process 800 as described below.

### Remote Server 112

The remote server 112 may, alone or in combination with the device 110 and the client device 140, (a) store the audio data, event template 120 and the records 130 as described below, (b) receive user input to generate the event templates 120 as described below, (c) process the audio data, the additional audio data and the event templates 120 to generate the records 130 as described below, and (d) process the audio data, the additional audio data and the event templates 120 to update the records 130 as described below.

In the embodiment shown in FIGS. 1 and 2, there is only a single remote server 112; in other embodiments, there may be more than one device 110 at a location of the conversation 106 or the event 100. In various embodiments, the device 110 includes at least one server processor 200, and a storage memory 202, a program memory 204 and an input/output (I/O) interface 206 all in communication with the server processor 200. Other embodiments of the remote server 112 may include fewer, additional or alternative components. Additionally, although only a single server processor 200, a single storage memory 202, a single program memory 204, and a single I/O interface 206 is shown in FIG. 2, other embodiments of the remote server 112 may include more than one of each of these components.

The storage memory 202 stores information received or generated by the server processor 200 and may generally function as an information or datastore. In the embodiment shown, the storage memory 202 includes corresponding versions of the event template datastore 201A (also referred to as the event template datastore 201), the transcript datastore 203A (also referred to as the transcript datastore 203) and the record datastore 205A (also referred to as the record datastore 205); in other embodiments, the storage memory 202 may include fewer, additional or alternative datastores. In some embodiments, different combinations of the device 110, the client device 140 and the remote server 112 may work in combination to store the event templates 120 in the corresponding event template datastore 201, the transcripts of the audio (or the additional audio) in the corresponding transcript datastore 203 and the records 130 and the records 130 in the corresponding record datastore 205 as described below.

The program memory 204 stores various blocks of code (alternatively called processor, machine and/or computer executable instructions), including codes for directing the server processor 200 to perform various processes, such as the generate/modify event template process 600A (also referred to as the generate/modify event template process 600), the populate event template process 700 (also referred to as the populate event template process 700) and the modify record process 800 (also referred to as the modify record process 800) as described below. The program memory 204 may also store database management system codes for managing the datastores in the storage memory 202. In some embodiments, different combinations of the device 110, the client device 140 and the remote server 112 may work together to perform the generate/modify event template process 600, the populate event template process 700 and the modify record process 800 as described below.

The I/O interface 206 comprises a network interface for receiving and transmitting information between the remote server 112 and different systems within the software platform 150, including the device 110 and/or the client devices 140. The I/O interface 226 may include any communication interface which enables the server processor 200 to communicate with external components, including specialized or standard I/O interface technologies such as channel, port-mapped, asynchronous for example. In some embodiments, the I/O interface 206 may be implemented using a network interface card (NIC), a port, and/or a network socket. For example, the remote server 112 may receive the audio data (or the additional audio data) and user input from the device 110 (or the client device 140). As a further non-nonlimiting example, the remote server 112 also communicates with additional systems external to the software platform 150, including the external model server 113 hosting the LLM described below. The external model server 113 may have increased processing capacity and computing resources for training and/or fine-tuning various machine learning models, including the generative language models described below.

Processes to be executed by different combinations of the remote server 112, the device 110 and the client device 140 in combination with a machine learning model are described in greater detail below. Certain of the processes described below may be implemented solely on the remote server 112, solely on the device 110, solely on the client device 140, or using a combination of the remote server 112, the device 110 or the client device 140 (e.g., the remote server 112 and the device 110, the remote server 112 and the client device 140, the device 110 and the client device 140, a combination of each of the device 110, the remote server 112 and the client device 140).

### Machine Learning Models and the External Model Server 113

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g., each data entry in the training dataset may be paired with a label), or may be unlabeled.

Training a ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

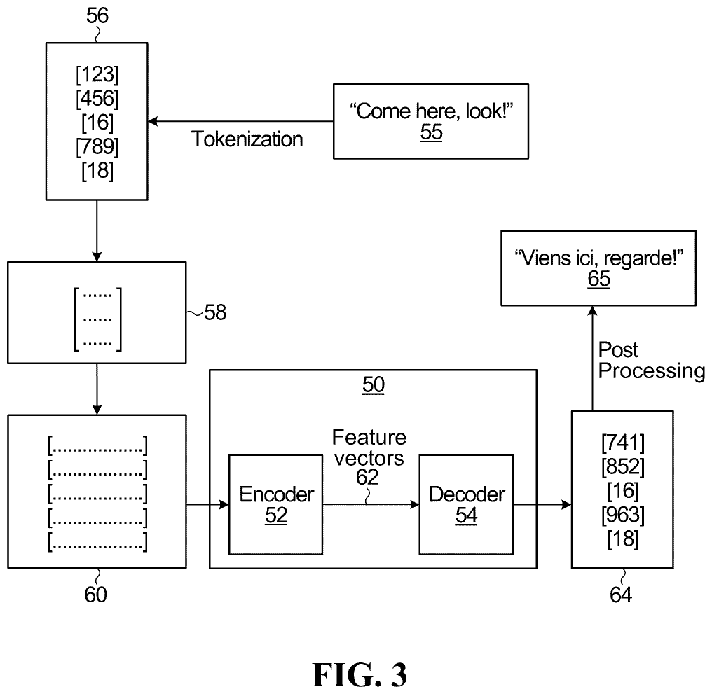

FIG. 3 is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 3, a short sequence of tokens 56 corresponding to the text sequence “Come here, look!” 55 is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 3 for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!” 65) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system, such as the remote server 112, the device 110 and the client device 140 described above, may access a remote language model (e.g., a cloud-based language model), such as ChatGPT or GPT-3 stored on the external model server 113 via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output (e.g., context), which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

Embodiments of the present disclosure herein relate to using a combination of the LLM stored on the external model server 113 and the software platform 150 to classify the conversation 106 (or the event 100) with a particular event type identifier based on the audio data (or the additional audio data), to retrieve a relevant event template 120 based on the classified event type identifier, to populate the event template based on the audio data (or the additional audio data or the transcripts thereof) to generate the record 130 of the conversation 106 (or the event 100), and to modify the record 130 based on additional user input.

### Generate/Modify Event Template Process 600

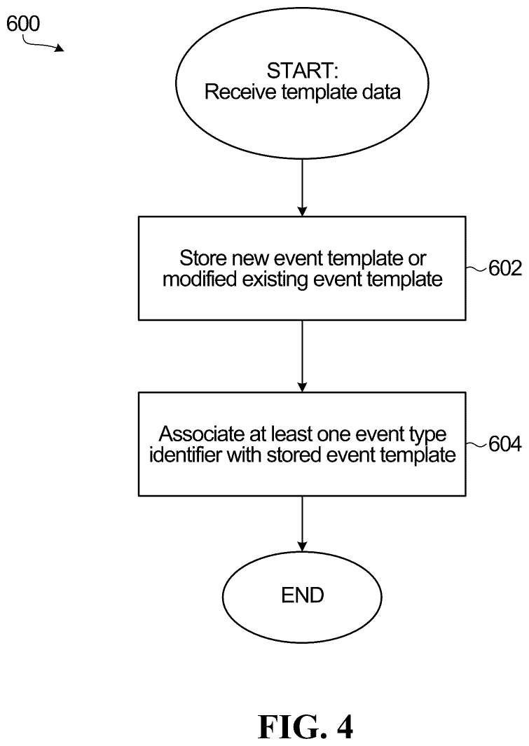

In some embodiments, one or more of the remote server 112, the device 110 and the client device 140 may be configured to allow the first party 102 or the user 105 to generate at least one new event template 120 and/or to edit at least one existing event template 120. Referring to FIGS. 2 and 4, a computer-implemented generate/modify event template process for generating at least one new event template 120 and/or modifying least one existing event template 120 in the event template datastore 201 is generally shown at 600.

In the embodiment shown, the generate/modify event template process 600 is performed by the device processor 220 executing processor, machine and/or computer readable instructions stored in the program memory 224 of the device 110. In other embodiments, the generate/modify event template process 600 may comprise processor, machine and/or computer readable instructions alternatively stored on other non-transitory computer readable storage medium such as a CD-ROM, a floppy disk, a hard drive, a DVD, a Blu-ray disk or another component associated with the device 110; in yet other embodiments, the generate/modify event template process 600 and/or parts thereof could alternatively be executed by a device other than the device processor 220, including for example, by the server processor 200 of the remote server 112 or the client device processor 240 of the client device 140. Further, although the generate/modify event template process 600 in accordance with one embodiment is described below with reference to the flowchart illustrated in FIG. 4, other methods of implementing the generate/modify event template process 600 may alternatively be used. For example, the order of execution of the blocks shown in FIG. 4 may be altered, and/or some of the blocks described may be altered, eliminated, or combined.

The generate/modify event template process 600 may be initiated in response to the device 110 receiving a user request for generating a new event template 120 for storage in the event template datastore 201 or for modifying at least one existing event template 120 already stored in the event template datastore 201. For example, the first party 102 or the user 105 may interact with the I/O interface 226 of the device 110 (or the user interface of the client device 140) to navigate to a generate/modify event template page displayed on the display of the device 110 and may select an “add” button (not shown) to initiate generation of a new event template 120 or an “edit” button (also not shown) associated with an existing event template 120 to initiate modification of that existing event template 120. Those skilled in the art would recognize that there are additional or alternative methods for receiving a user request to generate or modify at least one event template 120, and the embodiments described below are not intended to be limiting.

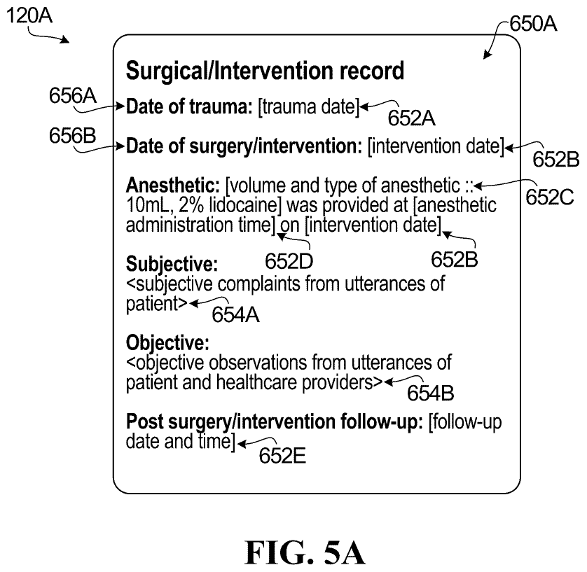

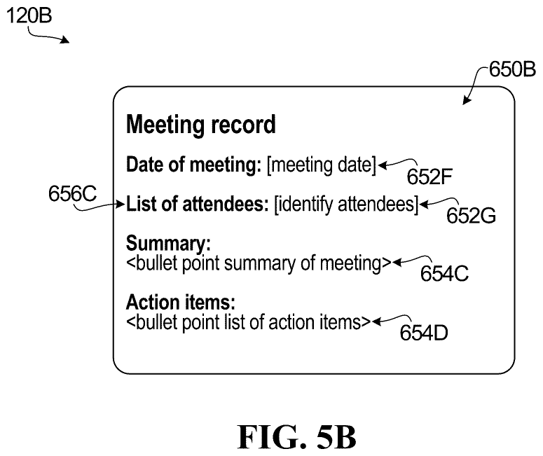

The first party 102 or the user 105 may then interact with the I/O interface 226 of the device 110 (or the user interface of the client device 140) to enter template data to generate the new event template 120 or to modify the existing event template 120. The template data generally includes fields to be associated with the event template 120 and which may be populated differently based on the audio data (or the additional audio data) of each conversation 106 (or event 100). The fields of a particular event template 120 may be categorized into different field types which may represent different ways that the LLM would be prompted to process the audio data and may be associated with different root prompts to be inputted into the LLM as described below in association with the populate event template process 700. Referring to FIG. 5A, one embodiment of an event template including template data 650A is shown at 120A. Referring to FIG. 5B, another embodiment of an event template including event template data 650B is shown at 120B.

The template fields may include one or more first field type, or one or more placeholder intent fields 652. Such placeholder intent fields 652 indicate fields that can be populated with relevant information extracted from the audio data by the LLM. A placeholder intent field may be associated with first field type identifiers; in some embodiments, the first field type identifiers may be square brackets delimiting text defining the placeholder intent field 652. As a specific example, referring to FIG. 5A, the first event template 120A includes “Date of trauma: [trauma date]”; “Date of surgery/intervention: [intervention date]”; “[volume and type of anesthetic::10 mL, 2% lidocaine] was provided at [anesthetic administration time] on [intervention date]”; “Post surgery/intervention follow-up: [follow-up date and time]”; whereby [trauma date] is a first placeholder intent field 652A, [intervention date] is a second placeholder intent field 652B, [volume and type of anesthetic::10 mL, 2% lidocaine] is a third placeholder intent field 652C, [anesthetic administration time] is a fourth placeholder intent field 652D and [follow-up date and time] is a fifth placeholder intent field 652E. As a further specific example, referring to FIG. 5B, the second event template 120B includes “Date of meeting: [meeting date]”; “List of attendees: [identity of attendees]”; whereby [meeting date] is a first placeholder intent field 652F and [identity of attendees] is a second placeholder intent field 652G.

The placeholder intent fields 652 may be populated by the LLM (during the populate event template process 700 described below) with relevant placeholder information searched and extracted from the audio data and utilizing placeholder intent prompts. In some embodiments, the placeholder intent prompts may specifically include the text defining the corresponding placeholder intent field 652. For example, a placeholder intent prompt to generate placeholder information associated with the first placeholder intent field 652A [trauma date] of the first event template 120A may specifically include the text “trauma date.” In some situations, the LLM may be able to find and extract the relevant placeholder information based on the audio data (or the transcript thereof) in response to the placeholder intent prompt. However, in some situations, the LLM may be unable to find and extract the relevant placeholder information, such as if the relevant placeholder information was not discussed during the conversation 106 (or the event 100). In such situations, the LLM may return a NULL value in response to the placeholder intent prompts.

Certain placeholder intent fields 652 may be associated with a default value. This default value may be user-defined (e.g., by the first party 102 or the user 105) or may be defined by an operator of the software platform 150. Such default values may be differentiated from the text identifying and delimiting placeholder intent field 652 itself by one or more default value separators; in some embodiments, the default value separators may be at least one colon. For example, the third placeholder intent field 652C [volume and type of anesthetic::10 mL, 2% lidocaine] of the first event template 120A includes the text defining the placeholder intent field “volume and type of anesthetic” and an associated default value “10 mL, 2% lidocaine”. Having default values associated with the placeholder intent fields 652 may enable the software platform 150 to populate the corresponding placeholder intent fields 652 with the default values when the LLM is unable to find and extract the relevant placeholder information from the audio data (or the transcript thereof). This can allow the event template 120 to be used to generate a complete record 130 even in situations where certain components of the record 130 are not explicitly spoken during the conversation 106 (or the event 100) but may form a standard operating procedure (SOP) associated with the conversation 106 (or the event 100).

The template fields may also include one or more second field type, or generator intent fields 654. Such generator intent fields indicate fields that can be populated with content generated by the LLM based on the audio data (or the additional audio data). A generator intent field may be associated with second field type identifiers; in some embodiments, the second field type identifiers may be angled brackets delimiting text defining the generator intent field 654. As a specific example, referring back to FIG. 5A, the first event template 120A includes “Subjective <subjective complaints based on utterances of patient>” and “Objective <objective observations based on utterances of patient and healthcare provider>”; whereby <summary of subjective complaints from utterances of patient> is a first generator intent field 654A and <summary of objective observations from utterances of patient and healthcare provider> is a second generator intent field 654B. As an additional example, referring back to FIG. 5B, the second event template 120B includes “Summary <bullet point summary of meeting>” and “Action Items <bullet point list action items>”; whereby <bullet point summary of meeting> may be a first generator intent field 654C and <bullet point list of action items> may be a second generator intent field 654D.

The generator intent field 654 may be populated by the LLM (also during the populate event template process 700 described below) with generator information generated by the LLM based on the audio data and utilizing generator intent prompts. In some embodiments, the generator intent prompts may specifically include the operator “generate” and may also include the text defining the corresponding generator intent field 654. For example, a generator intent prompts to generate generator information associated with the first generator intent field 654A <subjective complaints based on utterances of patient> of the first event template 120A may specifically include the text “generate subjective complaints based on utterances of the patient.” Use of the “generate” operator may allow the LLM to generate at least some generator information in response to input data of the audio data (or the transcript thereof), do at least in part to the training of the LLM. Accordingly, in a majority of situations, the LLM will be able to provide the generator information in response to the generator intent prompts.

The template fields may also include one or more third field type, or verbatim intent fields 656. Such verbatim intent fields 656 indicate fields that can be populated based on verbatim text from the event template 120. The verbatim intent fields 656 may not be delimited or identified by any field type identifiers or delimiters. As a specific example, referring to FIG. 5A, the first event template 120A includes “Date of trauma: [trauma date]” and “Date of surgery/intervention: [intervention date]”; whereby “Date of trauma:” is a first verbatim intent field 656A and “Date of surgery/intervention:” is a second verbatim intent field 656B. As the additional example, referring to FIG. 5B, the second event template 120B includes “Summary <bullet point summary of meeting>”; whereby “Summary” may be a first verbatim intent field 656C.

The verbatim intent field 656 may be populated (also during the populate event template process 700 described below) with verbatim text from the event template 120 and/or the audio data (or the transcript thereof). In some embodiments, the verbatim intent fields 656 may be populated by the software platform 150 itself, without utilizing any prompts into the LLM hosted on the external model server 113. Further, in some embodiments, the verbatim intent field 656 may be populated based on text defining the verbatim intent field 656 in the event template 120 itself, and may not consider the audio data (or the transcript thereof).

In response to receiving the template data from the first party 102 or the user 105, the generate/modify event template process 600 may continue to block 602, which may include codes directing the device processor 220 to store the new event template 120 or the modified existing event template 120 in the event template datastore 201. In some embodiments, block 602 may also direct the device processor 220 to transmit the new event template 120 or the modified existing event template 120 to the remote server 112 to enable the server processor 200 of the remote server 112 to perform the subsequent steps of the generate/modify event template process 600. As described above, a corresponding version of block 602 of the generate/modify event template process 600 stored on the program memory 204 of the remote server 112 may direct the server processor 200 to similarly store the received event template 120 in the event template datastore 201.

The generate/modify event template process 600 may then continue to block 604, which may include codes directing the device processor 220 or the server processor 200 to associate the new event template 120 or the modified existing template 120 with at least one event type identifier. The event type identifier may be used to classify the associated event template 120 into one or more event types. For example, the first event template 120A shown in FIG. 5A may be associated with a “surgical procedure” event type identifier, whereas the second event template 120B shown in FIG. 5B may instead be associated with an “administrative meeting” event type identifier.

In some embodiments, the first party 102 or the user 105 may manually enter the event type identifier to be associated with the event template 120, such as using the I/O interface 226 of the device 110 (or the user interface of the client device 140). In such embodiments, block 604 may involve storing the received event type identifier with the event template 120 in the event template datastore 201.

In some embodiments, block 604 may involve automatically generating the at least one event type identifier based on the event template 120. For example, block 604 may involve generating a classify event type prompt (for event templates) into the LLM including (a) input data comprising the event template 120 and (b) instructions directing the LLM to classify the event template 120 into an event type. As an example, the classify event type prompt may be human-readable and comprise: “Here is event template X. Generate an event type identifier for the event template X.” In other embodiments, the classify event type prompt may be machine-readable and comprise: “prompt”: {“<template X>”}, “completion”=“generate an event type identifier for the event template X”}. In some embodiments, the classify event type prompt may include existing event type identifiers and existing event templates classified with specific existing event type identifiers as context. For example, the event type classification prompt may comprise: “Event template A is an example of event type A. Event template B is an example of event type B. Here is event template X. Classify event template X as event type A or event type B.” Block 604 may then involve receiving the event type identifier generated by the LLM and storing the received event type identifier with the event template 120 in the event template datastore.

Block 604 may associate the event template 120 with a single event type identifier (e.g., one event template 120 may be associated with one event type identifier). Block 604 may also associate the event template 120 with more than one event type identifier (e.g., one event template 120 may be associated with multiple event type identifiers). The generate/modify event template process 600 may then end.

### Populate Event Template Process 700

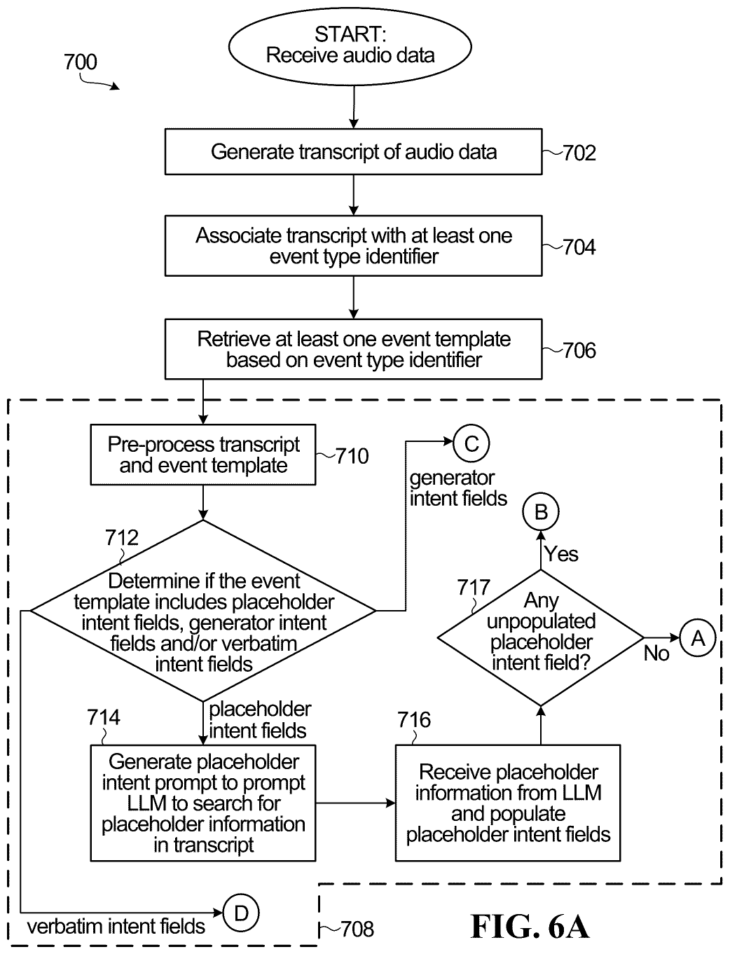

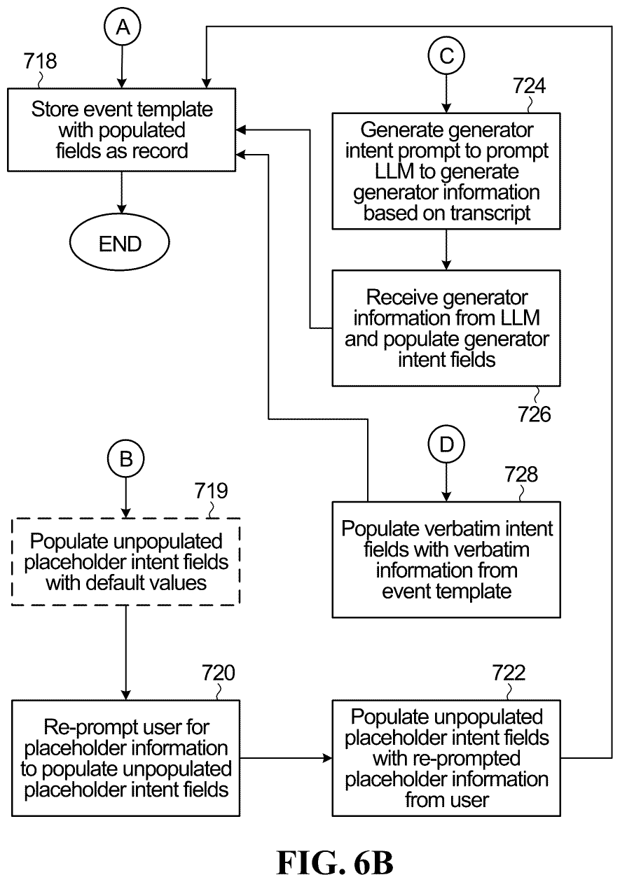

In some embodiments, one or more of the remote server 112, the device 110 and the client device 140 may be configured to (a) record the audio data of the conversation 106 (or the event 100) and the additional audio data generated by the first party 102 or the user after the conversation 106 (or the event 100) has occurred, (b) retrieve an event template 120 stored in the event template datastore 201 which may be relevant for the conversation 106 (or the event 100), and (c) process the audio data, the additional audio data and the retrieved event template 120 to generate the records 130 by populating the retrieved event template 120. One or more of the remote server 112, the device 110 and the client device 140 may specifically use the LLM to retrieve a relevant event template 120 and to populate this relevant event template 120 based on the audio data (or the transcript thereof). Referring to FIGS. 2, 6A, and 6B, a computer-implemented populate event template process for generating at least the record 130 based on the audio data of the conversation 106 (or the event 100) and the relevant event template 120 is shown is generally shown at 700.

The populate event template process 700 is performed by a combination of the device processor 220 executing processor, machine and/or computer readable instructions stored in the program memory 224 of the device 110 and the server processor 200 executing processor, machine and/or computer readable instructions stored in the program memory 204 of the remote server 112. In other embodiments, the populate event template process 700 may comprise processor, machine and/or computer readable instructions alternatively stored on other non-transitory computer readable storage medium such as a CD-ROM, a floppy disk, a hard drive, a DVD, a Blu-ray disk or another component associated with the device 110 or the remote server 112; in yet other embodiments, the populate event template process 700 and/or parts thereof could alternatively be executed by a device other than the server processor 200 or the device processor 220, including without limitation, by the processor of the client device 140. Further, although the populate event template process 700 in accordance with one embodiment is described with reference to the flowchart illustrated in FIGS. 6A and 6B, other methods of implementing the populate event template process 700 may alternatively be used. For example, the order of execution of the blocks shown in FIGS. 6A and 6B may be altered, and/or some of the blocks described may be altered, eliminated, or combined.

The populate event template process 700 may be initiated in response to the device 110 or remote server 112 receiving the audio data associated with the conversation 106 (or the event 100). For example, the first party 102 or the user 105 may actuate the device 110 at the beginning or, or during, the conversation 106 (or the event 100) to record the audio data. Alternatively, the remote server 112 may receive the audio data transmitted by the device 110 (or from one of the client devices 140). As described above, the audio data associated with the conversation 106 (or the event 100) may include an audio recording of the utterances 108 by the first party 102 and the second party 104 during the conversation 106 (or or the event 100) and the environmental noise during the conversation (or the event 100). In various embodiments, the device 110 and/or the remote server 112 may pre-process the audio data to remove or filter out the environmental noise, compress the audio data, remove undesired sections of the conversation 106, which may reduce data transmission loads or otherwise increase the speed of transmission of the audio data and increase the speed of processing the audio data.

In response to receiving the audio data, the populate event template process 700 may continue to block 702, which may include codes directing the server processor 200 or the device processor 220 to generate a transcript of the audio data. The transcript may be a text-based transcript. Those skilled in the art will recognize that there are numerous methods for generating a transcript based on the audio data, including both automated and manual methods. For example, in some embodiments, block 702 may involve generating a generate transcript prompt to be inputted the LLM, the generate transcript prompt including (a) input data comprising the audio data and (b) instructions directing the LLM to generate a text-based transcript based on the audio data. As an example, the generate transcript prompt may comprise: “Here is audio data X. Generate a text-based transcript X of the audio data X.” As another example, block 702 may instead input the audio data into a separate algorithm or a separate machine learning model (e.g., deep learning models, neural network models, other natural language models, etc.), such as one specifically adapted to generate text-based transcripts from an audio recording (including without limitation, the IBM Watson® Speech to Text, whisperX, NVIDIA® NeMo Canary, etc.) Block 702 may store the generated transcript in the transcript datastore 203.

The populate event template process 700 may then continue to block 704, which may include codes directing the server processor 200 or the device processor 220 to associate the transcript (or the audio data itself) with at least one event type identifier. The event type identifier may be one of the event type identifiers associated with the event templates 120 stored in the event template datastore 201 at block 604 of the generate/modify event template process 600 described above. In this regard, in some embodiments, each event type identifier may be associated with at least one of the event templates 120 stored in the event template datastore 201. Association of the transcript (or the audio data) with the event type identifier may enable the software platform 150 to retrieve at least one relevant event template 120 from the event template datastore 201 which can be populated based on the transcript (or the audio data) to generate the record 130.

In some embodiments, this association of the transcript with the at least one event type identifier may be done automatically by the server processor 200 or the device processor 220. In such embodiments, block 704 may involve categorizing the transcript (or the audio data) with at least one event type identifier. For example, block 704 may involve generating a classify event type prompt (for transcripts and/or audio data) into the LLM including (a) input data comprising the transcript (or the audio data); (b) context comprising the event type identifiers associated with the event type templates 120 stored in the event template datastore 201; and (c) instructions directing the LLM to classify the transcript (or the audio data) with one of the event type identifiers. As an example, the classify event type prompt may comprise: “Here is transcript X. The event type identifiers include event type identifier A and event type identifier B. Determine whether transcript X should be classified with event type identifier A or event type identifier B.”

The classify event type prompt may provide existing transcripts (or existing audio data) classified with existing event type identifiers as additional context. For example, the classify event type prompt may comprise: “Transcript A is an example of event type identifier A. Transcript B is an example of event type identifier B. Here is transcript X. Determine whether transcript X should be classified with event type identifier A or event type identifier B.” The classify event type prompt may also provide a default event type identifier, which may be an existing event type identifier or a standalone and unique default event type identifier. For example, where the default event type identifier is the existing event type identifier, the classify event type prompt may comprise: “Here is transcript X. The event type identifiers include event type identifier A and event type identifier B. Determine whether transcript X should be classified with event type identifier A or event type identifier B. If cannot determine whether transcript X should be classified with event type identifier A or event type identifier B, classify as event type identifier A.” Where the default event type identifier is a standalone default event type identifier, the classify event type prompt may comprise: “Here is transcript X. The event type identifiers include event type identifier A, event type identifier B, and event type identifier UNCLASSIFED. Determine whether transcript X should be classified with event type identifier A or event type identifier B. If cannot determine whether transcript X should be classified with event type identifier A or event type identifier B, classify as event type identifier UNCLASSIFIED.”

In some embodiments, this association may be based on user input from the first party 102 or the user 105. For example, block 704 may involve displaying a classify event type page (for transcripts and/or audio data, not shown) including the existing event type identifiers currently available (e.g., based on the event templates 120 stored in the event template datastore 201) on the I/O interface 226 of the device 110 (or the user interface of the client device 140). The first party 102 or the user 105 may interact with the I/O interface 226 (or the user interface) to select an event type identifier of displayed existing event type identifiers.

Further, in some situations, block 704 may be unable to automatically classify the transcript (or the audio data) with the at least one event type identifier in automatic embodiments and may default to manual embodiments. In other situations, block 704 may misclassify the transcript (or the audio data) and it may be desirable to otherwise confirm the automatic classification generated by block 704. Accordingly, block 704 may involve displaying a confirm event type identification notification on the I/O interface 226 of the device 110 (or the user interface of the client device 140). The confirm event type identification notification may prompt the first party 102 or the user 105 to interact with the I/O interface 226 (or the user interface) to (a) generate a new event type identifier to be associated with the transcript, (b) select an existing event type identifier to be associated with the transcript, (c) confirm an event type identifier automatically generated by block 704, and/or (d) designate that the default event type identifier should be associated with the transcript.

Block 704 may associate the transcript (or the audio data) with a single event type identifier (e.g., one transcript may be associated with one event type identifier). Block 704 may also associate the transcript (or the audio data) with more than one event type identifier (e.g., one transcript may be associated with multiple event type identifiers). Block 704 may store the received or generated event type identifier with the transcript (or the audio data) in the transcript datastore 203.

The populate event template process 700 then continues to block 706, which may include codes directing the server processor 200 or the device processor 220 to retrieve at least one corresponding event template 120 (e.g., from the event template datastore 201) based on the event type identifier associated with the transcript (or the audio data) at block 704. As described above, in some embodiments, one event template may be associated with one event type identifier; in such embodiments, block 706 may involve (a) retrieving the one event template 120 corresponding to the event type identifier associated with the transcript at block 704 (in embodiments where the transcript is also associated with one event type identifier), or (b) retrieve, and present for user selection on the I/O interface 226 of the device 110 (or the user interface of the client device 140), more than one event template 120 corresponding to the more than one event type identifier associated with the transcript at block 704 (in embodiments where the transcript is associated with more than one event type identifier). As also described above, in some embodiments, one event template 120 may be associated with more than one event type identifier; in such embodiments, block 706 may (a) retrieve, and present for user selection on the I/O interface 226 (or the user interface), more than one event template 120 corresponding to the event type identifier associated with the transcript at block 704 (in embodiments where the transcript is associated with one event type identifier), or (b) retrieve, and present for user selection on the I/O interface 226 (or the user interface), more than one event template 120 corresponding to each of the more than one event type identifier associated with the transcript at block 704 (in embodiments where the transcript is also associated with more than one event type identifier).

As described above, associating the transcript (or the audio data) with an event type identifier at block 704 and then retrieving an event template 120 based on this event type identifier at block 706 can allow the software platform 150 to leverage the LLM hosted on the external model server 113 generate the record 130 of the conversation 106 (or the event 100) based on the audio data thereof faster, more accurately and using less processing power (e.g., of the server processor 200 or the device processor 220) when compared to existing computer-implemented methods of generating the record 130 based on audio data. The event template 120 provides a structured format for processing and extracting relevant information from the transcript (or the audio data). The event template 120 may also reduce the processing power required to generate the record 130 by providing specific root prompts to the LLM. The combination of block 704 and block 706 thus enables the software platform 150 to retrieve an event template corresponding to a specific event type of the conversation 106 (or the event 100), which can facilitate faster and more accurate generation of the record 130 of the conversation 106 (or the event 100).

In some embodiments, block 706 may be unable to automatically retrieve at least one corresponding event template 120 based on the event type identifier associated with the transcript (or the audio data) and may default to manual embodiments. In such manual embodiments, block 706 may instead involve displaying an unretrievable template notification on the I/O interface 226 of the device 110 (or the user interface of the client device 140). The unretrievable template notification may prompt the first party 102 or the user 105 to interact with the I/O interface 226 (or the user interface) to (a) generate a new event template 120, (b) select another existing event template 120 from the event template datastore 201 and/or (b) designate that a default event template should be selected. For example, the default event template may be subjective, objective, assessment, plan (SOAP) note. The default event template may also be a generic summary note.

In response to retrieving or otherwise identifying an event template 120 at block 706, the populate event template process 700 then continues to block 708, which may include codes directing the server processor 200 or the device processor 220 to perform an initial population of the event template 120 with the transcript (or the audio data) to generate the record 130. Block 708 may involve generating different prompts to be inputted into the LLM based on the different field types present in the event template 120.

For example, block 708 may include subblock 710, which may include codes directing the server processor 200 or the device processor 220 to pre-process the transcript (or audio data) and/or the event template 120 for input into the LLM. For example, subblock 710 may involve dividing the transcript (or audio data) into a plurality of portions, whereby each portion may be represented by a number of tokens equal to or less than the number of input tokens which can be accepted by the LLM. Subblock 710 may also involve dividing the event template 120 into a plurality of segments, whereby each segment may be represented by a number of tokens equal to or less than the number of input tokens which can be accepted by the LLM.

Subblock 710 may specifically divide the transcript into the plurality of portions and/or the event template 120 into the plurality of segments based on an “utterance-level” division. In this regard, rather than dividing the transcript or the event template 120 by a number of words (a “world-level” division) or characters (a “character-level” division), subblock 710 may instead divide the transcript or the event template 120 by utterance-level attributes, such as speaker identity, speaking style, speaker intention, speaker emotion, etc. For example, in some embodiments, subblock 710 may generate an input prompt into the LLM including (a) input data comprising the transcript (or the audio data) and/or the event template 120 and (b) instructions directing the LLM to divide the transcript (or the audio data) or the event template 120 into a number of “utterances” based on utterance-level attributes. In other embodiments, subblock 710 may instead input the transcript (or the audio data) and/or the event template 120 into a separate algorithm or a separate machine learning model (e.g., deep learning models, neural network models, other natural language models, etc.), such as one specifically adapted to divide a transcript of dialogue or other text data into utterance-level divisions (including without limitation, DialogUSR, Deepgram's Utterance Split, etc.).

Different combinations of the plurality of portions of the transcript and the plurality of segments of the event template 120 may be processed by other blocks of the populate event template process 700 and may be used in prompts to the LLM as described below. For example, a particular transcript may be divided into portion 1, portion 2 and portion 3, and a particular event template 120 may be divided into segment 1 and segment 2. Other blocks of the populate event template process 700 may, for example, (a) input portion 1 and segment 1 in a first prompt to be inputted into the LLM, (b) portion 1 and segment 2 in a second input prompt to be inputted into the LLM, (c) portion 2 and segment 1 in a third prompt to be inputted into the LLM, (d) portion 2 and segment 2 in a fourth prompt to be inputted into the LLM, etc.

Block 708 may also include subblock 712, which may include codes directing the server processor 200 or the device processor 220 to process the plurality of segments of the event template 120 to determine whether the event template 120 includes the different field types described above. Specifically, subblock 712 may involve determining whether the event template 120 includes the placeholder intent fields 652, the generator intent fields 654 and the verbatim intent fields 656. In some embodiments, subblock 712 may involve (a) identifying if a segment of the plurality of segments is associated with one or more placeholder intent identifiers of the square brackets to determine if the segment has one or more placeholder intent fields 652; (b) identifying if the segment is associated with one or more generator intent identifiers of the angled brackets to determine if the segment includes one or more generator intent fields 654; and (c) identifying if the segment is associated text having no identifiers or delimiters to determine if the segment is associated with one or more verbatim intent fields 656.

### Placeholder Intent Fields 652 and Re-Prompting

In response to determining at subblock 712 that the event template 120 includes one or more placeholder intent fields 652, block 708 may continue to subblock 714, which may include codes directing the server processor 200 or the device processor 220 to process the plurality of portions of the transcript and the plurality of segments of the event template 120 and to search the transcript (or the audio data) for placeholder information based on the placeholder intent fields 652 which can be used to populate the placeholder intent fields 652.

For example, subblock 714 may involve generating at least one placeholder intent prompt for input into the LLM, wherein the placeholder intent prompt may include (a) input data comprising the transcript (or the audio data, or a portion thereof) and (b) instructions directing the LLM to search the transcript (or the audio data, or a portion thereof) to find placeholder information associated with the placeholder intent field 652. In some embodiments, as described above, the input data and/or the instructions of the placeholder intent prompt may specifically include the text defining the placeholder intent field 652. As a more specific example, referring back to FIG. 5A, the first event template 120A includes [trauma date] as the first placeholder intent field 652A, [intervention date] as the second placeholder intent field 652B, [volume and type of anesthetic::10 mL, 2% lidocaine] as the third placeholder intent field 652C, [anesthetic administration time] as the fourth placeholder intent field 652D and [follow-up date and time] as the fifth placeholder intent field 652E (collectively referred to as the placeholder intent fields 652). The placeholder intent prompt into the LLM may comprise: “Based on transcript X, find [trauma date], [intervention date], [volume and type of anesthetic::10 mL, 2% lidocaine], [anesthetic administration time], and [follow-up date and time].” In other embodiments, where the event template 120 includes placeholder intent fields 652 with respect to, e.g., age and gender of the patient, subblock 714 may involve generating the placeholder intent prompt to prompt the LLM to search the transcript to find placeholder information concerning, e.g., the age and gender of the patient.

Block 708 may then continue to subblock 716, which may include codes directing the server processor 200 or the device processor 220 to receive the extracted placeholder information from the LLM and to populate the placeholder intent fields 652 of the event template 120 with the extracted placeholder information.

Block 708 may then continue to subblock 717, which may include codes directing the server processor 200 or the device processor 220 to determine whether each placeholder intent field 652 in the event template 120 (or each placeholder intent field 652 in a designated portion of the event template 120) has been populated by subblock 716. In other words, subblock 717 may involve determining whether there are any unpopulated placeholder intent fields 652 in the event template 120 (or the designated portion of the event template 120), or if any of the placeholder information required is absent from the transcript.

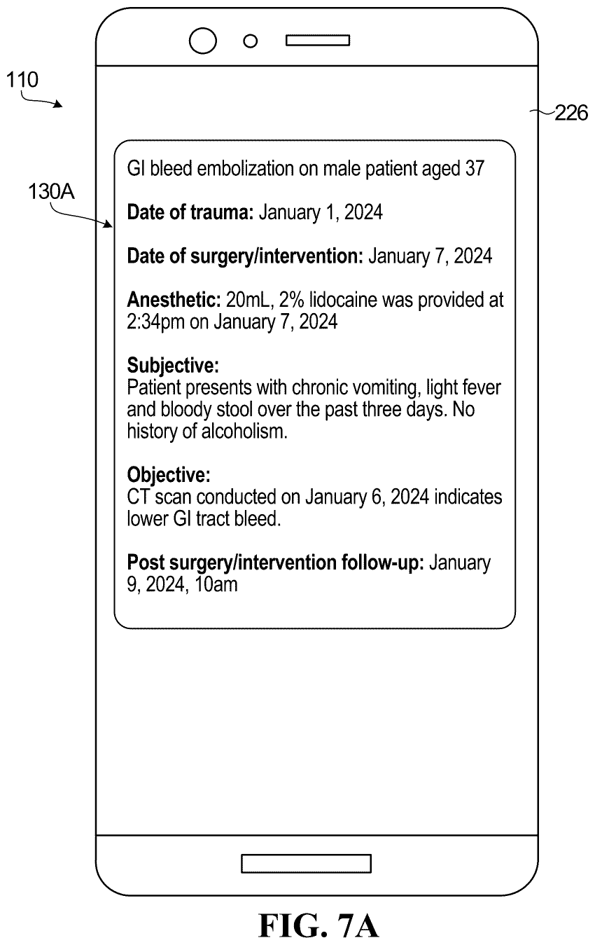

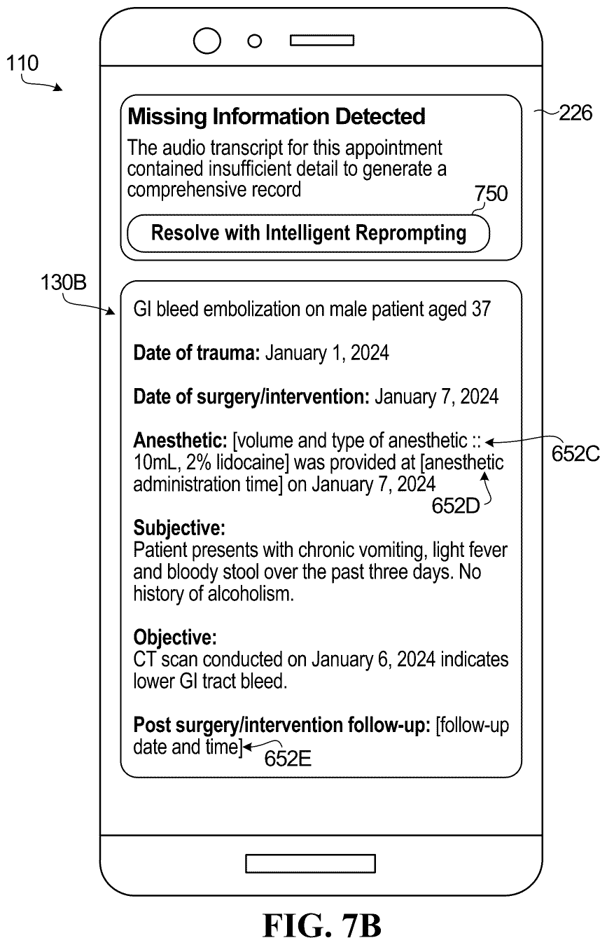

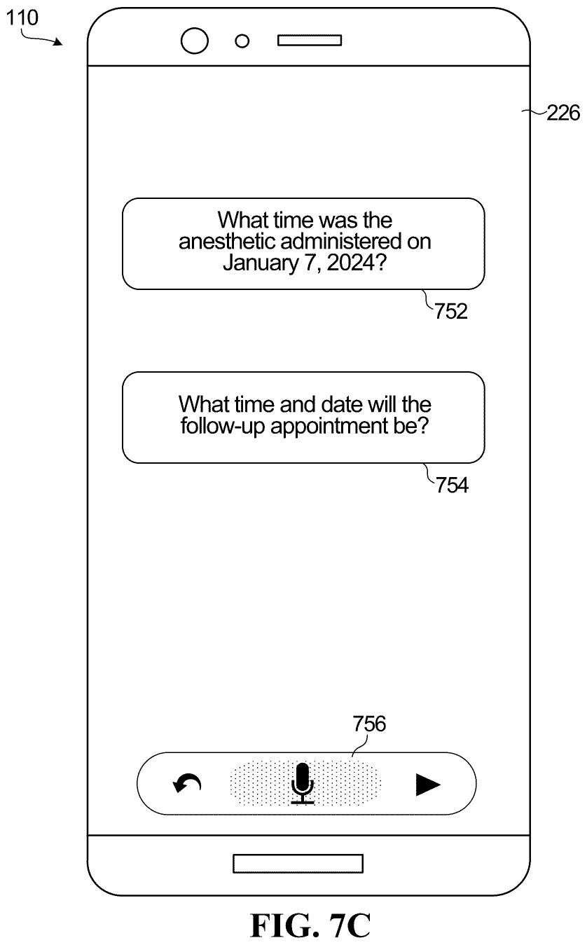

In some situations, subblock 716 may be able to populate every one of the placeholder intent fields 652 of the event template 120 with the placeholder information received from the LLM. For example, in response to the prompt above, the LLM may return with placeholder information such as “[trauma date=Jan. 1, 2024], [intervention date=Jan. 7, 2024], [volume and type of anesthetic=20 mL, 2% lidocaine], [anesthetic administration=2:34 PM], [follow-up date and time=Jan. 9, 2024, 10 AM]. Referring to FIG. 7A, subblock 716 may then generate a record shown at 130A with: Date of trauma: Jan. 1, 2024; Date of surgery/intervention: Jan. 7, 2024; 20 mL, 2% lidocaine was provided at 2:34 PM on Jan. 7, 2024; Post surgery/intervention follow-up: Jan. 9, 2024, 10 AM. In such situations, subblock 717 may determine that there are no unpopulated placeholder intent fields 652 in the first event template 120A and block 708 may continue to subblock 718, which may include codes directing the server processor 200 or the device processor 220 to save the event template 120 with the populated placeholder intent fields 652 as the record 130 in the record datastore 205.

However, in other situations, subblock 716 may not be able to populate every one of the placeholder intent fields 652 of the event template 120 with the placeholder information received from the LLM. For example, the LLM may be unable to find, in the transcript (or the audio data), the placeholder information for one or more of the placeholder intent fields 652 of the event template 120 (e.g., the relevant placeholder information may be absent from the transcript). In such situations, subblock 716 may leave some of the placeholder intent fields 652 unpopulated (i.e., unpopulated placeholder intent fields 652). As a specific example, the LLM may be unable to return any placeholder information for the [volume and type of anesthetic::10 mL, 2% lidocaine] placeholder intent field 652C, [anesthetic administration time] placeholder intent field 652D and [follow-up date and time] placeholder intent field 652E. Referring to FIG. 7A, subblock 716 may instead generate an record as shown at 130B with: “Date of trauma: Jan. 1, 2024; Date of surgery/intervention: Jan. 7, 2024; [volume and type of anesthetic::10 mL, 2% lidocaine] was provided at [anesthetic administration time] on January 7, 2024; Post surgery/intervention follow-up: Jan. 9, 2024, 10 AM.”

In such situations, subblock 717 may determine that there are unpopulated placeholder intent fields 652 in the event template 120 and block 708 may continue to optional subblock 719. Optional subblock 719 may include codes directing the server processor 200 or the device processor 220 to determine whether certain unpopulated placeholder intent fields 652 may include default values and to populate such unpopulated placeholder intent fields 652 with the associated default values rather than leaving such unpopulated placeholder intent fields 652 blank. Optional subblock 719 may determine whether there are default values associated with a placeholder intent field 652 by determining whether the placeholder intent field 652 includes a default value identifier such as the at least one colon. As a specific example, in the example noted above, the LLM may be unable to return any placeholder information for the [volume and type of anesthetic::10 mL, 2% lidocaine] placeholder intent field 652C; however, the placeholder intent field 652C is associated with the default value “10 mL, 2% lidocaine”. Optional subblock 719 may involve generating the record 130 as “Date of surgery/intervention: Jan. 7, 2024; 10 mL, 2% lidocaine was provided at [anesthetic administration time] on January 7, 2024.” rather than leaving the placeholder intent field 652C.

Additionally, when subblock 717 determines that there are unpopulated placeholder intent fields 652 in the event template 120, block 708 may also continue to optional subblock 720. Subblock 720 may include codes directing the server processor 200 or the device processor 220 to re-prompt the first party 102 or the user 105 to provide additional user input of placeholder information to populate the unpopulated placeholder intent field 652. For example, referring back to FIGS. 5A and 7B, in situations where the record 130 includes at least one unpopulated placeholder intent fields 652 of the event template 120 (e.g., placeholder intent fields 652D and 652E), subblock 717 may involve displaying a re-prompting button 750 on the I/O interface 226 of the device 110 (or the user interface of the client device 140) associated with the record 130. The first party 102 or the user 105 may interact with the I/O interface 226 (or the user interface) to select the re-prompting button 750 to initiate re-prompting of the first party 102 or the user 105 to provide additional audio data.

For example, in response to user selection of the re-prompting button 750, subblock 720 may involve generating one or more re-prompts for the first party 102 or the user 105 requesting the first party 102 or the user 105 to provide additional placeholder information based on the unpopulated placeholder intent fields 652. The re-prompt may specifically include a question to the user generated by the LLM based on the unpopulated placeholder intent field 652. For example, subblock 720 may involve generating a re-prompting prompt into the LLM including (a) input data comprising the unpopulated placeholder intent fields 652 and (b) instructions directing the LLM to generate a question asking the first party 102 or the user 105 to provide the placeholder information to be used to populate the unpopulated placeholder intent fields 652. In some embodiments, the re-prompting prompt may specifically include the text defining the unpopulated placeholder intent field 652. For example, referring back to FIG. 7A, subblock 717 may determine that the LLM was unable to return any placeholder information for the [anesthetic administration time] placeholder intent field 652D and the [follow-up date] placeholder intent field 654E. Subblock 719 may then determine that the [anesthetic administration time] placeholder intent field 652D and the [follow-up date] placeholder intent field 652E do not have associated default values. In response to user selection of the re-prompting button 750, subblock 720 may generate the re-prompting prompt including: “Generate a past tense question asking a user to provide the [anesthetic administration time]. Generate a past tense question asking a user to provide [follow-up date].”

Subblock 720 may also involve receiving the re-prompting questions from the LLM and displaying the re-prompting questions from the LLM on the I/O interface 226 of the device 110 (or the user interface of the client device 140). For example, referring to FIG. 7C, subblock 718 may involve directing the I/O interface 226 (or the user interface) to display a first re-prompting question 752 “What time was the anesthetic administered on Jan. 7, 2024” associated with the unpopulated [anesthetic administration time] placeholder intent field 652D and a second re-prompting question 754 “What time and date will the follow-up appointment be” associated with the unpopulated [follow-up date] placeholder intent field 652E. The first party 102 or the user 105 may interact with the I/O interface 226 (or the user interface) to select either the re-prompting questions 752 or 754.

In response to user selection of one of the re-prompting question 752 or 754, block 708 may proceed to subblock 722, which may include codes directing the server processor 200 or the device processor 220 to receive re-prompted input representing answers to the re-prompting questions 752 or 754 and to populate the unpopulated placeholder intent fields 652 based on the re-prompted user input. The re-prompted user input may be additional audio data generated by activating the microphone of the device 110 (or the client device 140). For example, the first party 102 or the user 105 may hold or toggle a microphone button 756 displayed on the I/O interface 226 of the device 110 and may record additional audio data via the microphone of the device 110. The additional audio data may be processed to generate an additional transcript (e.g., in a manner similar to block 702 described above) and the additional transcript (or the additional audio data) may be used to populate the unpopulated placeholder intent fields 652 (e.g., in a manner similar to subblock 716 described above). The re-prompted user input may also be text data entered by actuating the keyboard, the touchscreen or another text-based input device of the device 110 (or the client device 140). In such embodiments, the text data may be directly used to populate the unpopulated placeholder intent fields 652.

Subblocks 719 and 720 outline different ways in which missing (e.g., absent) placeholder information can be generated. These blocks may enable generation of a comprehensive record 130 based on either the default values or the re-prompt. This may also reduce the amount of time required for the first party 102 or the user 105 to generate the comprehensive record 130.

Block 708 may continue to subblock 718 as described above. Subblock 718 may involve saving the event template 120 with the populated placeholder intent fields 652 as the record 130 in the record datastore 205.

### Generator Intent Fields 654

Referring back to FIGS. 6A and 6B, in response to determining at subblock 712 that the event template 120 includes the one or more generator intent fields 654, block 708 may continue to subblock 724, which may include codes directing the server processor 200 or the device processor 220 to process the transcript and the generator intent fields 654 to generate generator information which can be used to populate the generator intent fields 654.

For example, subblock 724 may involve generating at least one generator intent prompt for input into the LLM, wherein the generator intent prompt may include (a) input data comprising the transcript (or the audio data, or a portion thereof) and (b) instructions directing the LLM to generate the generator information based on the transcript (or the audio data, or a portion thereof). In some embodiments, as described above, the input data and/or the instructions of the generator intent prompt may specifically include the text defining the generator intent field 654. As a more specific example, referring back to FIG. 5A, the first event template 120A includes <subjective complaints from utterances of patient> as the first generator intent field 654A and <objective observations from utterances of patient and healthcare provider> as the second generator intent field 654B (collectively referred to as the generator intent fields 654). The generator intent prompt into the LLM may comprise: “Based on transcript X, generate <summary of subjective complaints from utterances of patient>. Based on transcript X, generate <objective observations from utterances of patient and healthcare provider>.”

Block 708 may then continue to subblock 726, which may include codes directing the server processor 200 or the device processor 220 to receive the generated generator information from the LLM and to populate the generator intent fields 654 of the event template 120 with the generated generator information. As a generative language model, the LLM may be adapted to generate the generator information in a majority of situations in which the transcript (or the audio data) of the conversation 106 (or the event 100) is provided to the LLM; in other words, the LLM is adapted and trained to generate at least some generator information in response to an input prompt including a “generate” operator. Accordingly, in a majority of situations, subblock 726 will receive at least some generator information generated by the LLM in response to the generator intent prompt and will populate the generator intent fields 654 with such generator information. For example, in response to the generator intent prompt of “Based on transcript X, generate <summary of subjective complaints from utterances of patient>,” the LLM may output generator information of “Patient presents with chronic vomiting, light fever and bloody stool over the past three days. No history of alcoholism.” Similarly, in response to the generator intent prompt of “Based on transcript X, generate <summary of objective observations based on utterances of patient and caregiver>” the LLM may output generator information of “CT scan conducted on Jan. 6, 2024 indicates lower GI track bleed.” Referring to FIGS. 7A and 7B, subblock 726 may then generate the record 130A with: Subjective: Patient presents with chronic vomiting, light fever and bloody stool over the past three days. No history of alcoholism; Objective: CT scan conducted on Jan. 6, 2024 indicates lower GI track bleed.

Block 708 may then continue to subblock 718 as described above. Subblock 718 may involve saving the event template 120 with the populated generator intent fields 654 as the record 130 in the record datastore 205.

### Verbatim Intent Fields 656

Referring back to FIGS. 6A and 6B, in response to determining at subblock 712 that the event template 120 includes the one or more verbatim intent fields 656, block 708 may continue to subblock 728, which may include codes directing the server processor 200 or the device processor 220 to process the plurality of portions of the transcript and the plurality of segments of the event template 120 and to reproduce verbatim information based on the verbatim intent fields 656.

In certain embodiments, the verbatim information may be provided by the software platform 150 itself, without utilizing any prompts into the LLM. In additional embodiments, in some embodiments, the verbatim intent field 656 may be populated based on text defining the verbatim intent field 656 in the event template 120 itself, and may not consider the audio data (or the transcript thereof). For example, subblock 728 may involve reproducing, as the verbatim information, the text defining the verbatim intent fields 656 of the event template 120 (e.g., carrying over the text defining the verbatim intent fields 656 in the event template 120 to the record 130). For example, referring back to FIG. 5A, the first event template 120A includes “Date of trauma:” as the first verbatim intent field 656A and “Date of surgery/intervention:” as the second verbatim intent field 656B. Referring to FIGS. 7A and 7B, subblock 728 may reproduce the text of the first and second verbatim intent fields 656 to generate the record 130A with “Date of trauma; Date of surgery/intervention:”

Block 708 may then continue to subblock 718 as described above. Subblock 718 may involve saving the event template 120 with the populated verbatim intent fields 656 as the record 130 in the record datastore 205. Block 708 generally allows different types of fields in the event template 120 to be identified and populated in a different manner using the LLM. This can help to increase efficiency and accuracy of using the LLM to generate the record 130 as the LLM is provided with specific prompts relevant to the corresponding information (e.g., “search and retrieve” the placeholder information but “generate” the generator information).

After subblock 718, the populate event template process 700 may produce the record 130 of the conversation 106 (or the event 100) based on the transcript (or the audio) of the conversation 106 (or the event 100) along with the event template 120 sharing an event type identifier with the conversation 106 (or the event 100). The populate event template process 700 may then end.

### Modify Record Process 800

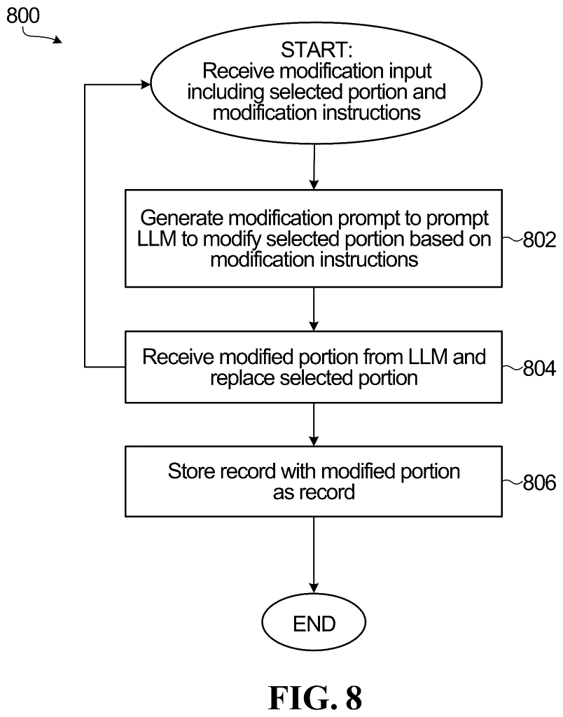

In some embodiments, one or more of the remote server 112, the device 110 and the client device 140 may be configured to use the LLM to modify or otherwise edit the record 130 associated with the conversation 106 (or the event 100) generated by the populate event template process 700 described above. Referring to FIGS. 2 and 8, a computer-implemented edit record process for modifying the record 130 based on the additional audio data of the conversation 106 (or the event 100) is shown is generally shown at 800.

In the embodiment shown, the modify record process 800 is performed by a combination of the device processor 220 executing processor, machine and/or computer readable instructions stored in the program memory 224 of the device 110 and the server processor 200 executing processor, machine and/or computer readable instructions stored in the program memory 204 of the remote server 112. In other embodiments, the modify record process 800 may comprise processor, machine and/or computer readable instructions alternatively stored on other non-transitory computer readable storage medium such as a CD-ROM, a floppy disk, a hard drive, a DVD, a Blu-ray disk or another component associated with the device 110 or the remote server 112; in yet other embodiments, the modify record process 800 and/or parts thereof could alternatively be executed by a device other than the server processor 200 or the device processor 220, including without limitation, by processor of the client device 140. Further, although the modify record process 800 in accordance with one embodiment is described with reference to the flowchart illustrated in FIG. 8, other methods of implementing the modify record process 800 may alternatively be used. For example, the order of execution of the blocks shown in FIG. 8 may be altered, and/or some of the blocks described may be altered, eliminated, or combined.

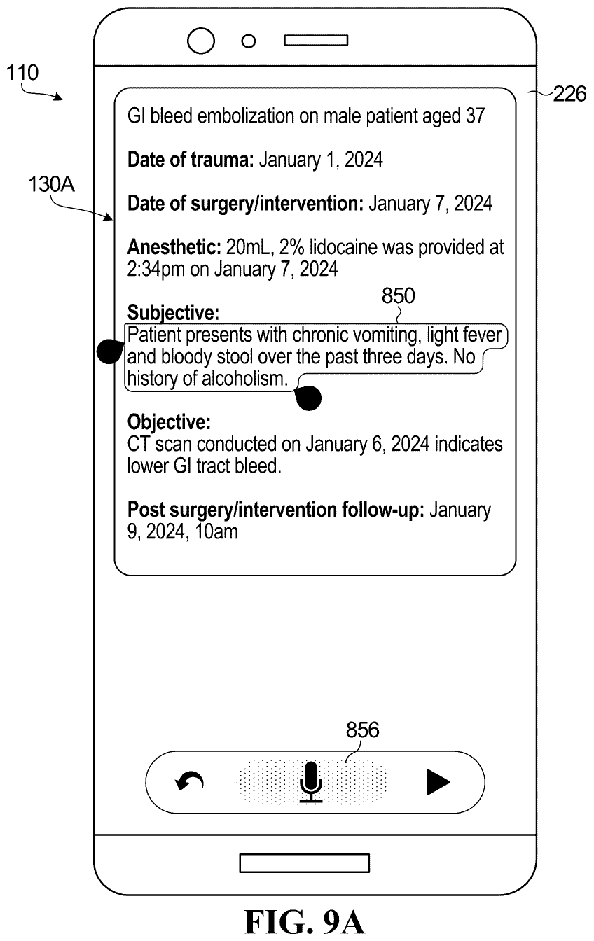

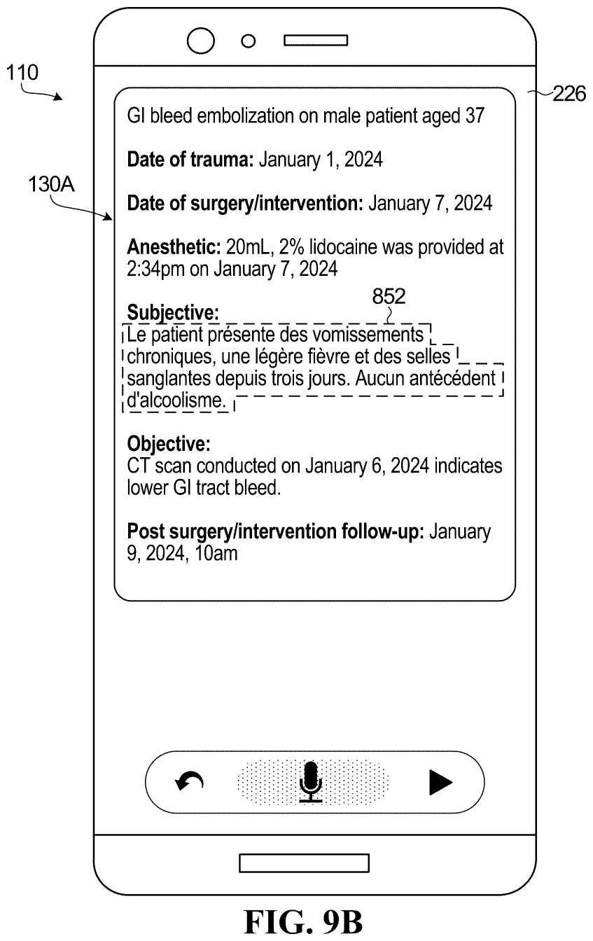

The modify record process 800 may be initiated in response to the device 110 or remote server 112 receiving a modification input to modify the record 130 generated using the populate event template process 700 described above. The modification input may include a selected portion of the record 130 and modification instructions. For example, referring to FIG. 9A, while the first party 102 or the user 105 is reviewing the record 130A which may be displayed on the I/O interface 226 of the device 110 (or the user interface of the client device 140), the first party 102 or the user 105 may interact with the I/O interface 226 (or the User interface) to highlight or otherwise select a portion 850 of the record 130A. The first party 102 or the user 105 may also provide the modification instructions which may serve as instructions to edit or modify the selected portion 850. The modification instruction may include any instruction or operator for modifying the selected portion 850, including without limitation “translate into French,” “delete,” “make more concise,” “provide more detail,” etc. The modification instruction may be modification audio data generated by activating the microphone of the device 110 (or the client device 140). For example, referring to FIG. 9A, the first party 102 or the user 105 may hold or toggle a microphone button 856 displayed on the I/O interface 226 of the device 110 and may record modification audio data via the microphone. In other embodiments, the modification instruction may also be modification text data entered by actuating the keyboard, the touchscreen or another text-based input device of the device 110 (or the client device 140).

In response to receiving the selected portion 850 and the modification instruction (i.e., collectively the modification input), the modify record process 800 may continue to block 802, which may include codes directing the server processor 200 or the device processor 220 to generate at least one modification of the selected portion 850 based on the modification input. For example, block 802 may involve generating a modification prompt into the LLM including (a) input data comprising the selected portion 850 and (b) instructions directing the LLM modify the selected portion 850 according to the modification instructions. In some embodiments, the modification prompt may further include (c) context comprising the transcript (or the audio data) generated at block 702 of the populate event template process 700. For example, the modification prompt may comprise: “Modify [selected portion 850] based on instructions of [modification instructions]. Here is transcript X which was used to generate [selected portion 850].” As a more specific example, referring to FIG. 9A, the selected portion 850 may be “Patient presents with chronic vomiting, light fever and bloody stool over the past three days. No history of alcoholism.” and the modification instruction may be “translate into French.” The modification prompt generated at block 802 may comprise: “Modify ‘Patient presents with chronic vomiting, light fever and bloody stool over the past three days. No history of alcoholism’ based on instructions of ‘translate into French’.” The LLM may generate the modified portion 852 “Le patient présente des vomissements chroniques, une légère fièvre et des selles sanglantes depuis trois jours. Aucun antécédent d'alcoolisme.” in response to the modification prompt generated at block 802.

The edit record process 800 may then continue to block 804, which may include codes directing the server processor 200 or the device processor 220 to receive the modified portion 852 generated by the LLM and to replace the selected portion 850 with the modified portion 852. As a more specific example, referring to FIGS. 9A and 9B, the selected portion 850 may be “Patient presents with chronic vomiting, light fever and bloody stool over the past three days. No history of alcoholism.” (shown in FIG. 9A) and the modified portion 852 may be “Le patient présente des vomissements chroniques, une légère fièvre et des selles sanglantes depuis trois jours. Aucun antécédent d'alcoolisme.”

The edit record process 800 may then return to the start to wait for another modification input. The edit record process 800 may also continue to block 806, which may include codes directing the server processor 200 or the device processor 220 to store the record 130 with the modified portion 852 in the record datastore 205. The edit record process 800 may then end.

The edit record process 800 allows the software platform 150 to provide a user-friendly, LLM assisted, editing functionality. In particular, the first party 102 or the user 105 could simply select/highlight a portion of the record 130 (or any other text document) and start speaking to provide modification instructions. This generates a prompt to the LLM and leverages the LLM to generate a modified portion without requiring significant additional input from the first party 102 or the user 105. Providing the selected portion 850, the modification instructions and the transcript (e.g., used to generate the selected portion 850) in the modification prompt into the LLM may improve accuracy and speed at which the LLM can generate the modified portion 852 to replace the selected portion.

### CONCLUSION

Embodiments of the present disclosure herein relate to using a generative language model (e.g., an LLM) to classify a conversation or an event with a particular event type identifier based on audio data of the conversation or the event, to retrieve a relevant event template based on the classified event type identifier, to populate the event type template based on the audio data (or a transcript of the audio data), to generate a record of the conversation or the event based on the transcript and the event template, and to modify the record based on additional user input.

It should be understood that the event templates 120, the records 130 and the re-prompting questions 752 and 754 are illustrated to be displayed on a graphic user interface (GUI) on the device 110. This is only illustrative and is not intended to be limiting. In other examples, the event templates 120, the records 130 and the re-prompting questions 752 and 754 may be output in other format.

It is also noted that although, in some embodiments, user input (e.g., the user's answer to the pre-prompt question, the user's modification instruction) is illustrated to be input by voice via a gesture of holding GUI microphone buttons 756 and 856 with reference to FIGS. 7C and 9B, this is not intended to be limiting. As discussed above, in other possible alternative examples, the user's input may be provided in any suitable manner, such as keyboard, mouse, other gestures (e.g., tapping, scrolling, rotation, double click) on a touch screen of a device.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

Although the present disclosure describes methods and processes with steps in a certain order, one or more steps of the methods and processes may be omitted or altered as appropriate. One or more steps may take place in an order other than that in which they are described, as appropriate.

A person skilled in the art can make various modifications and variations to this application without departing from the scope of this disclosure. This disclosure is intended to cover these modifications and variations of this application provided that they fall within the scope of protection defined by the following claims and their equivalent technologies.

1. A method of generating a record for an event based on audio data of the event, the method comprising:
retrieving an event template associated with the event;
determining whether the event template includes at least one placeholder intent field and/or at least one generator intent field;
in response to determining that the event template includes the at least one placeholder intent field, prompting a machine learning model to search a transcript of the audio data for placeholder information associated with the at least one placeholder intent field to populate the at least one placeholder intent field, wherein prompting the machine learning model to search the transcript comprises:
determining if the placeholder information associated with the at least one placeholder intent field is absent from the transcript; and
in response to determining that the placeholder information associated with the at least one placeholder intent field is absent from the transcript, prompting the machine learning model to generate a re-prompt to a user to provide the placeholder information; and
in response to determining that the event template includes the at least one generator intent field, prompting the machine learning model to process the transcript to generate generator information to populate the at least one generator intent field.

2. The method of claim 1, the method further comprising:
receiving an input from the user as a response to the re-prompt; and
prompting the machine learning model to process the input of the user to populate the at least one placeholder intent field.

3. The method of claim 1, wherein the re-prompt comprises a question to the user generated by the machine learning model based on the at least one placeholder intent field, and the method further comprising:
receiving an input from the user as an answer to the question; and
prompting the machine learning model to process the input of the user to populate the at least one placeholder intent field.

4. The method of claim 1, wherein:
prompting the machine learning model to search the transcript for the placeholder information comprises providing text of the at least one placeholder intent field and at least a portion of the transcript to the machine learning model; and
prompting the machine learning model to process the transcript to generate the generator information comprises providing text of the at least one generator intent field and at least a portion of the transcript to the machine learning model.

5. The method of claim 1, the method further comprising:
determining whether the event template includes at least one verbatim intent field; and
in response to determining that the event template includes the at least one verbatim intent field, reproduce verbatim information associated with the at least one verbatim intent field from the event template to populate the at least one verbatim intent field.

6. The method of claim 1, the method further comprising:
dividing the event template into a plurality of segments, wherein determining whether the event template includes the at least one placeholder intent field and/or the at least one generator intent field includes:
identifying if a segment of the plurality of segments is associated with one or more placeholder intent identifiers; and
identifying if a segment of the plurality of segments is associated with one or more generator intent identifiers.

7. The method of claim 6, wherein identifying if the segment of the plurality of segments is associated with the one or more placeholder intent identifiers comprises determining if the segment is delimited by one or more square brackets.

8. The method of claim 6, wherein identifying if the segment of the event template is associated with the one or more generator intent identifiers comprises determining if the segment is delimited by one or more angled brackets.

9. The method of claim 1, the method further comprising:
receiving a modification input from the user, the modification input including a selected portion of the record and modification instructions for modifying the selected portion; and
prompting the machine learning model to generate a replacement portion to replace the selected portion based on the modification input and the transcript.

10. The method of claim 1, the method further comprising:
recording the audio data of the event with at least one device.

11. The method of claim 1, the method further comprising:
converting the audio data of the event into the transcript;
prompting the machine learning model to classify the transcript with an event type identifier; and
retrieving the event template based on the classified event type identifier of the transcript.

12. The method of claim 11, the method further comprising, in response to determining that the classified event type identifier does not correspond to any event type identifier saved in an event template datastore, outputting one or more event type identifiers for the user to manually select.

13. A system of generating a record for an event based on an audio data of the event, the system comprising:
a processor; and
a non-transitory computer readable storage medium storing instructions which, when executed by the processor, cause the processor to:
retrieve an event template associated with the event;
determine whether the event template includes at least one placeholder intent field and/or at least one generator intent field;
in response to determining that the event template includes the at least one placeholder intent field, prompt a machine learning model to search a transcript of the audio data for placeholder information associated with the at least one placeholder intent field to populate the at least one placeholder intent field, wherein the instructions which cause the processor to prompt the machine learning model to search the transcript comprise instructions which cause the processor to:
determine if the placeholder information associated with the at least one placeholder intent field is absent from the transcript; and
in response to determining that the placeholder information associated with the at least one placeholder intent field is absent from the transcript, prompt the machine learning model to generate a re-prompt to a user to provide the placeholder information; and
in response to determining that the event template includes the at least one generator intent field, prompt the machine learning model to process the transcript to generate generator information to populate the at least one generator intent field.

14. The system of claim 13, wherein the instructions further cause the processor to:
receive an input from the user as a response to the re-prompt; and
prompt the machine learning model to process the input of the user to populate the at least one placeholder intent field.

15. The system of claim 13, wherein the re-prompt comprises a question to the user generated by the machine learning model based on the at least one placeholder intent field, and wherein the instructions further cause the processor to:
receive an input from the user as an answer to the question; and
prompt the machine learning model to process the input of the user to populate the at least one placeholder intent field.

16. The system of claim 13, wherein the instructions further cause the processor to:
determine whether the event template includes at least one verbatim intent field; and
in response to determining that the event template includes the at least one verbatim intent field, reproduce verbatim information associated with the at least one verbatim intent field from the event template to populate the at least one verbatim intent field.

17. The system of claim 13, wherein the instructions further cause the processor to divide the event template into a plurality of segments, wherein the instructions which cause the processor to determine whether the event template includes the at least one placeholder intent field and/or the at least one generator intent field comprises instructions which cause the processor to:
identify if a segment of the plurality of segments is associated with one or more placeholder intent identifiers; and
identify if a segment of the plurality of segments is associated with one or more generator intent identifiers.

18. The system of claim 13, wherein the instructions further cause the processor to:
receive a modification input from the user, the modification input including a selected portion of the record and modification instructions for modifying the selected portion; and
prompt the machine learning model to generate a replacement portion to replace the selected portion based on the modification input and the transcript.

19. The system of claim 13, wherein the system further comprises at least one device configured to record the audio data of the event.

20. A non-transitory computer-readable medium storing instructions thereon, wherein the instructions are executable by a processor to cause the processor to perform a method of generating a record for an event, the method comprising:
retrieving an event template associated with the event;
determining whether the event template includes at least one placeholder intent field and/or at least one generator intent field;
in response to determining that the event template includes the at least one placeholder intent field, prompting a machine learning model to search a transcript of audio data of the event for placeholder information associated with the at least one placeholder intent field to populate the at least one placeholder intent field, wherein prompting the machine learning model to search the transcript comprises:
determining if the placeholder information associated with the at least one placeholder intent field is absent from the transcript; and
in response to determining that the placeholder information associated with the at least one placeholder intent field is absent from the transcript, prompting the machine learning model to generate a re-prompt to a user to provide the placeholder information; and
in response to determining that the event template includes the at least one generator intent field, prompting the machine learning model to process the transcript to generate generator information to populate the at least one generator intent field.
